(19) United States
(12) Patent Application Publication
(10) Pub. No.: US 2006/0060051 A1
(43) Pub. Date: Mar. 23, 2006

(54) Anti-vibration device for use with circular saw

(75) Inventors: Anatoly Gosis, Palatine, IL (US); Richard L. Edwards, Cary, IL (US); Michael D. Loeschen, Hawthorn Woods, IL (US); Ron Gustafson, Woodridge, IL (US)

Correspondence Address: Steven W. Weinrieb;SCHWARTZ & WEINRIEB, Crystal Plaza One, Suite 1109, 2001 Jefferson Davis Highway, Arlington, VA, 22202, US

(73) Assignee: ILLINOIS TOOL WORKS INC.

(21) Appl. No.: 10/945,931

(22) Filed: Sep. 22, 2004

(51) Int. Cl. B26D 1/00

(52) U.S. Cl. 83/651

(57) ABSTRACT

A tool system comprises a circular saw blade which is adapted to be moved in a reciprocating manner between an elevated, RETRACTED, INOPERATIVE position and a lowered, EXTENDED, OPERATIVE position so as to repeatedly form slits within side wall members of a packaging structure at a plurality of positions which are located at predeterminedly defined locations spaced along and throughout the longitudinal or axial extent of the packaging structure. A compression implement is movable along with the circular saw blade and has a split, U-shaped or clevis-type configuration so as to define a pair of compression arms or legs. The pair of arms or legs of the compression implement are respectively disposed immediately adjacent to the opposite sides of the circular saw blade whereby, as the circular saw blade and the compression implement are moved from the elevated, RETRACTED, INOPERATIVE position toward the lowered, EXTENDED, OPERATIVE position, such that the pair of arms or legs of the compression implement will engage those portions of the side wall member of the packaging structure which are disposed immediately adjacent to the location within which the particular slit is to be formed by the circular saw blade so as to effectively compress or deflect such portions of the side wall member of the packaging structure against a fixed, underlying elongated anvil or support block. In this manner, the tendency of those portions of the side wall member of the packaging structure to flex and vibrate are effectively eliminated so as to facilitate the proper, accurate, clean, and smooth formation of the particular slit within the side wall member of the packaging structure.

### FIELD OF THE INVENTION

The present invention relates generally to a tool system, and more particularly to a new and improved tool system comprising a circular saw blade which is adapted to be moved in a reciprocating manner between an elevated, RETRACTED, INOPERATIVE position and a lowered, EXTENDED, OPERATIVE position so as to repeatedly form slits within side wall members of a packaging structure at a plurality of positions which are located at predeterminedly defined locations spaced along and throughout the longitudinal or axial extent of the packaging structure, and a compression implement which is movable along with the circular saw blade, and which has a split, U-shaped or clevis-type configuration so as to define a pair of compression arms or legs, the pair of arms or legs of the compression implement being respectively disposed immediately adjacent to the opposite sides of the circular saw blade whereby as the circular saw blade and the compression implement are moved from the elevated, RETRACTED, INOPERATIVE position toward the lowered, EXTENDED, OPERATIVE position, the pair of arms or legs of the compression implement will engage those portions of the side wall member of the packaging structure which are disposed immediately adjacent to the location within which the particular slit is to be formed by the circular saw blade so as to effectively compress such portions of the side wall member of the packaging structure against a fixed, underlying elongated anvil or support block whereby the tendency of those portions of the side wall member of the packaging structure to flex and vibrate will effectively be eliminated so as to facilitate the proper, accurate, clean, and smooth formation of the particular slit within the side wall member of the packaging structure.

### BACKGROUND OF THE INVENTION

Various articles, having substantial width, thickness, and length dimensions need to be protected during, for example, the transportation and shipping thereof from their manufacturing facilities to their storage and/or point of sale locations so as to prevent damage from occurring to such articles prior to the purchase of the same by consumers. It is conventional practice to utilize substantially rigid, laminated U-shaped or channel-shaped packaging structures so as to effectively define composite packaging containers, which encase the articles therewithin, whereby the packaging structures can subsequently be secured together by means of, for example, suitable strapping or banding. One type of conventional packaging structure, which has been utilized for the foregoing purposes, is disclosed, for example, within U.S. Pat. No. 4,976,374 which issued to Macaluso on Dec. 11, 1990. More particularly, as disclosed within FIG. 1, which substantially corresponds to FIG. 3 of the aforenoted patent, it is seen that the composite packaging container comprises a substantially U-shaped base unit 10 and a substantially U-shaped cover unit 12. The substantially U-shaped base unit 10 is seen to comprise a base or bottom portion 10a, and a pair of oppositely disposed, upstanding side wall or leg members 10b,10c integrally connected to the base or bottom portion 10a, while the substantially U-shaped cover unit 12 is seen to comprise a cover or top portion 12a, and a pair of oppositely disposed, dependent side wall or leg members 12b,12c integrally connected to the cover or top portion 12a.

Alternatively, in lieu of utilizing two separate packaging structures, such as, for example, the base unit 10 and the cover unit 12, so as to form the composite packaging container, a single packaging structure can be utilized by effectively forming slits within the side wall members of the packaging structure at predetermined locations along the longitudinal extent of the packaging structure. In this manner, the packaging structure is effectively divided into sections which are integrally connected together in an articulated manner whereby the various sections can effectively be bent at predetermined angles with respect to each other so as to effectively form a composite packaging container within which predetermined articles can be packaged. In connection with the fabrication of such articulated packaging structures, it is noted that the slits are conventionally formed within the side wall members of the packaging structure by means of, for example, a circular saw blade which is movable in a reciprocating manner within a vertically oriented plane. More particularly, the circular saw blade is located, for example, at a fixed cutting station, and the packaging structure is moved along its longitudinal or axial extent with respect to the fixed cutting station. Therefore, when a slit is to be formed at a predetermined location within a particular one of the side wall members of the packaging structure, the longitudinal movement of the packaging structure is terminated, and the circular saw blade is moved vertically downwardly from its elevated, RETRACTED, INOPERATIVE position, toward its lowered, EXTENDED, OPERATIVE position, during which time the circular saw blade encounters the side wall member of the packaging structure and thereby forms the slit within a particularly located side wall portion thereof.

Subsequently, when the stroke or movement of the circular saw blade has reached its terminal end point whereby the cutting operation is completed, the circular saw blade is moved vertically upwardly from its lowered, EXTENDED, OPERATIVE position and back to its elevated, RETRACTED, INOPERATIVE position in preparation for the performance of a subsequent cutting operation. Upon reaching the terminal end point of its upstroke movement, the packaging structure is advanced along its longitudinal or axial extent for a predeterminedly defined distance, the movement of the packaging structure is subsequently stopped, and accordingly, the cutting operation cycle may be repeated so as to permit the circular saw blade to cut another slit within the side wall member of the packaging structure at the new longitudinal or axial position of the packaging structure which is now located at the cutting station. It is to be noted further that, in connection with the use of the circular saw blade, and the movement of the same with respect to the packaging structure so as to in fact form a slit within the side wall member of the U-shaped packaging structure, the U-shaped packaging structure is effectively supported upon a fixed elongated anvil or support block during both the time at which the packaging structure is being moved along its longitudinal or axial extent so as to effectively have different axial positions thereof located at the cutting station, as well as during the time at which the packaging structure is effectively stationary so as to in fact permit the circular saw blade to form a slit within the side wall member of the packaging structure.

A problem is often encountered, however, when the circular saw blade initially encounters the packaging structure during the time at which the circular saw blade is commencing a cutting operation upon the packaging structure in connection with the formation of a particular slit at a particular axial or longitudinal location within the side wall member of the packaging structure. More particularly, it is to be noted and appreciated that the lateral or transverse distance defined between the oppositely disposed side wall members of the U-shaped packaging structure is slightly larger than the lateral or transverse width dimension of the aforenoted elongated anvil or support block, upon which the U-shaped packaging structure is effectively supported, so as to permit the U-shaped packaging structure to in fact be freely movable in the aforenoted translational manner along its axial or longitudinal extent with respect to the fixed underlying elongated anvil or support block. Therefore, it is to be noted and appreciated still further that the side wall members of the packaging structure are normally spaced or separated from the side wall members of the underlying anvil or support block by means of a predetermined distance. Accordingly, when the circular saw blade initially makes contact with the side wall member of the packaging structure, within which the slit is to be formed, the contact pressure of the circular saw blade, as impressed upon the side wall member of the packaging structure, within which the slit is to be formed, will cause the side wall member of the packaging structure to flex, move, and vibrate until the side wall member of the packaging structure traverses the aforenoted space or distance separating the same from the side wall member of the underlying anvil or support block whereby the side wall member of the packaging structure can then in fact be fixedly supported upon the side wall member of the underlying anvil or support block. It can therefore be appreciated that such initial flexure, movement, and vibration of the side wall member of the packaging structure will cause the slit to be formed within the side wall member of the packaging structure in an inaccurate manner whereby the formed slit will also exhibit rough edge portions and improper alignment or orientation with respect to the longitudinal axis of the packaging structure.

A need therefore exists in the art for a new and improved tool system, comprising a circular saw blade for forming slits within side wall members of a packaging structure, wherein those portions of the side wall member of the packaging structure, which are disposed upon opposite sides of the location at which the slit is to be formed, will be properly and adequately supported against the underlying anvil or support block immediately prior to and during the cutting operation performed by the circular saw blade such that the slit can be formed within the side wall member of the packaging structure in a proper, accurate, clean, and smooth manner.

### SUMMARY OF THE INVENTION

The foregoing and other objectives are achieved in accordance with the teachings and principles of the present invention through the provision of a new and improved tool system comprising a circular saw blade which is adapted to be moved in a reciprocating manner between an elevated, RETRACTED, INOPERATIVE position and a lowered, EXTENDED, OPERATIVE position so as to repeatedly form slits within side wall members of a packaging structure at a plurality of positions which are located at predeterminedly defined locations spaced along and throughout the longitudinal or axial extent of the packaging structure, and a compression implement which is movable along with the circular saw blade, and which has a split, U-shaped or clevis-type configuration so as to define a pair of compression arms or legs. The pair of arms or legs of the compression implement are respectively disposed immediately adjacent to the opposite sides of the circular saw blade whereby, as the circular saw blade and the compression implement are moved from the elevated, RETRACTED, INOPERATIVE position toward the lowered, EXTENDED, OPERATIVE position, the pair of arms or legs of the compression implement will engage those portions of the side wall member of the packaging structure which are disposed immediately adjacent to the location within which the particular slit is to be formed by the circular saw blade so as to effectively compress such portions of the side wall member of the packaging structure against a fixed, underlying elongated anvil or support block. In this manner, the tendency of those portions of the side wall member of the packaging structure to flex and vibrate will effectively be eliminated so as to facilitate the proper, accurate, clean, and smooth formation of the particular slit within the side wall member of the packaging structure.

### BRIEF DESCRIPTION OF THE DRAWINGS

Various other features and attendant advantages of the present invention will be more fully appreciated from the following detailed description when considered in connection with the accompanying drawings in which like reference characters designate like or corresponding parts throughout the several views, and wherein:

FIG. 1 is a perspective view of a conventional PRIOR ART packaging assembly comprising mating packaging structures;

FIG. 2 is a side elevational view of a tool system comprising a circular saw blade and a side wall member compression implement movable with the circular saw blade, wherein the circular saw blade and the side wall member compression implement are movable between a first elevated RETRACTED, INOPERATIVE position and a second lowered EXTENDED, OPERATIVE position, the circular saw blade and the side wall member compression implement being illustrated at their respective elevated RETRACTED, INOPERATIVE positions;

FIG. 3 is a side elevational view, similar to that of FIG. 2, showing the tool system comprising the circular saw blade and the side wall member compression implement movable with the circular saw blade between the first elevated RETRACTED, INOPERATIVE position and the second lowered EXTENDED, OPERATIVE position, the circular saw blade and the side wall member compression implement being illustrated at their respective lowered EXTENDED, OPERATIVE positions; and

FIG. 4 is a side elevational view of the tool system illustrated within FIG. 1, comprising the circular saw blade and the side wall member compression implement, as taken along the lines 4-4 of FIG. 1.

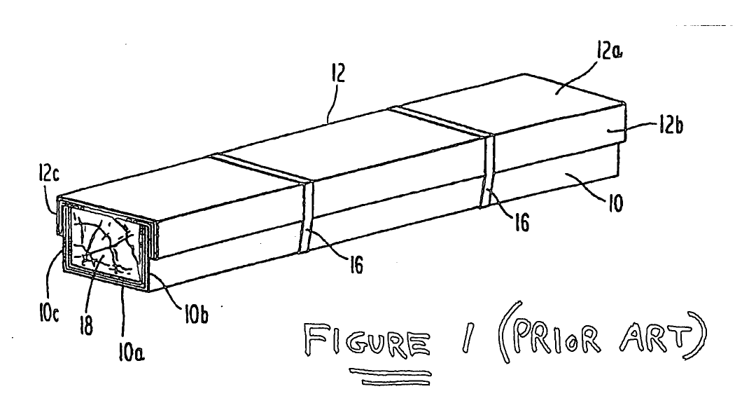

### DETAILED DESCRIPTION OF THE PREFERRED EMBODIMENT

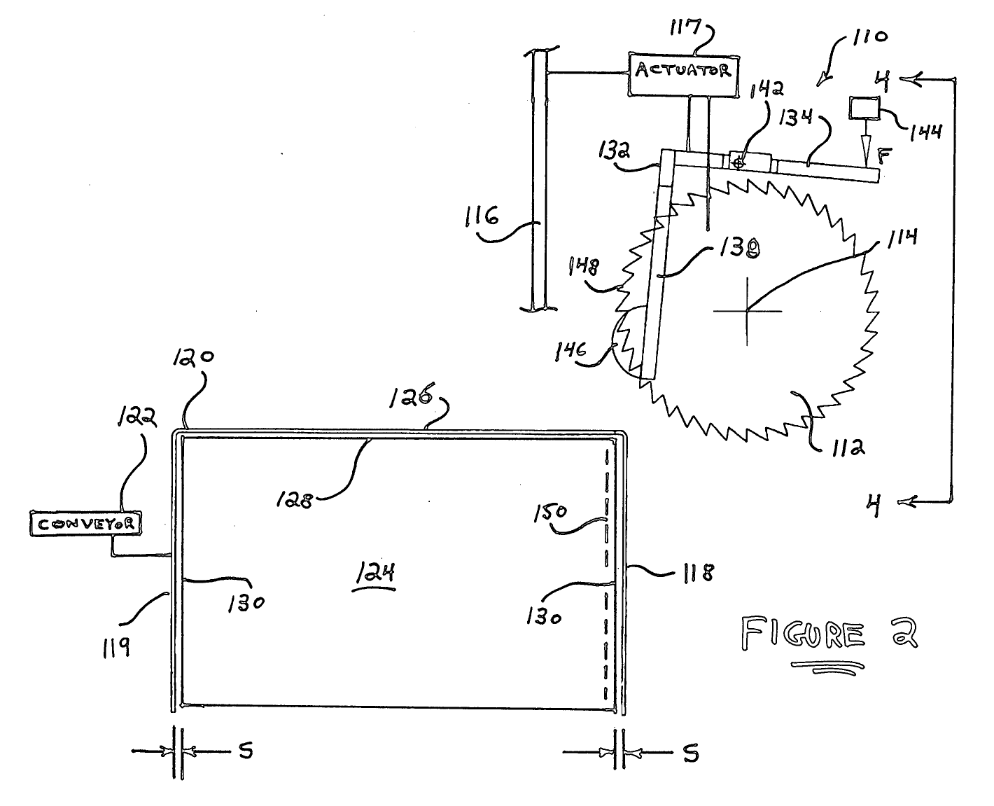

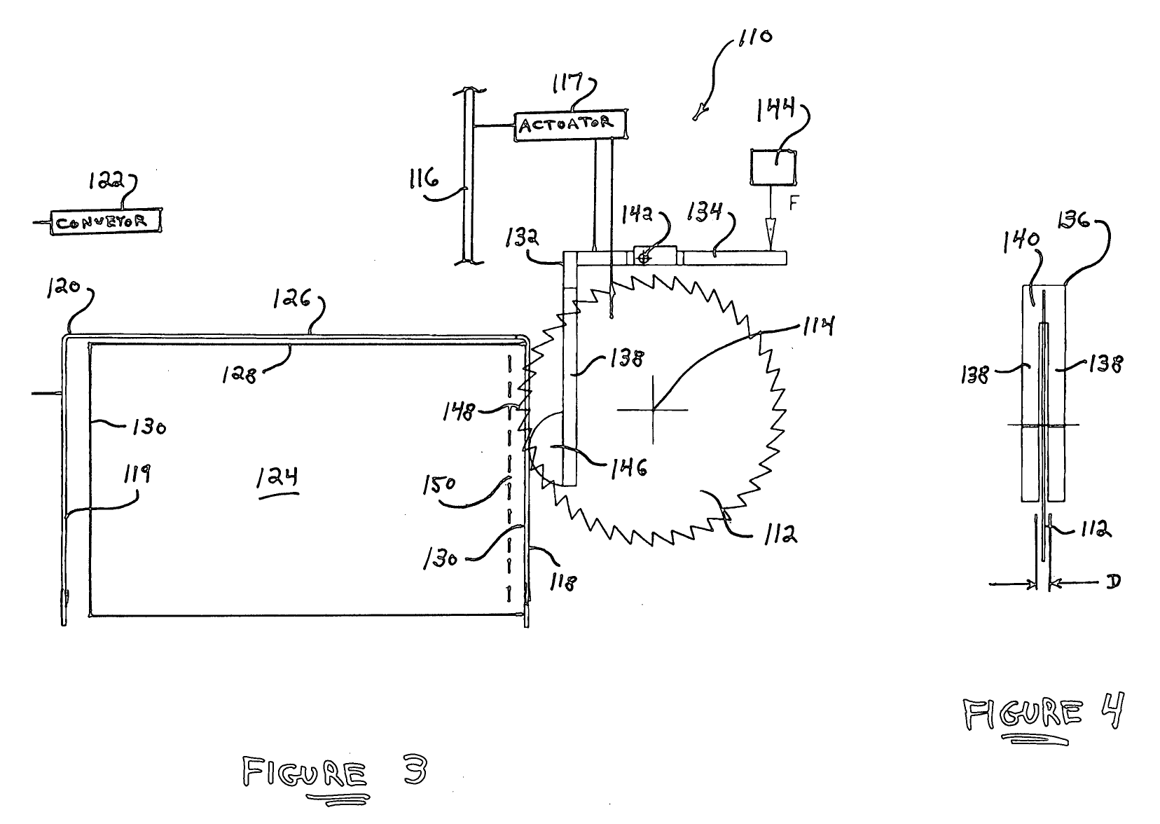

Referring now to the drawings, and more particularly to FIGS. 2 and 3 thereof, a new and improved tool system, constructed in accordance with the principles and teachings of the present invention, is disclosed and is generally indicated by the reference character 110. More particularly, it is seen that the tool system 110 comprises a circular saw blade 112 which is rotatable around an axis 114 and which is adapted to be mounted upon a suitable framework 116 so as to be movable with respect to the framework 116 within a vertical plane between a first elevated, RETRACTED, INOPERATIVE position, as illustrated within FIG. 2, and a second lowered, EXTENDED, OPERATIVE position as illustrated within FIG. 3, under the influence of a suitable actuator mechanism 117, such as, for example, a pneumatic cylinder, a servo mechanism, or the like. In this manner, the vertical plane, within which the circular saw blade 112 is movable between the first elevated RETRACTED, INOPERATIVE position and the second lowered EXTENDED, OPERATIVE position, effectively defines a cutting station at which a slit can be formed at a predetermined axial position within, for example, a side wall member 118 of a packaging structure 120, as considered along the axial or longitudinal extent of the packaging structure 120, as the circular saw blade 112 is moved between the first elevated RETRACTED, INOPERATIVE position and the second lowered EXTENDED, OPERATIVE position. The packaging structure 120 has a substantially U-shaped cross-sectional configuration and is adapted to be moved in a translational mode, and in a stepwise manner, along the longitudinal or axial direction of the packaging structure 120 such that when the circular saw blade 112 is repetitively moved in a reciprocating manner between the first elevated RETRACTED, INOPERATIVE position and the second lowered EXTENDED, OPERATIVE position, a plurality of slits can be serially formed within the side wall member 118 of the packaging structure 120 at different predetermined, axially or longitudinally spaced positions throughout the longitudinal or axial extent of the packaging structure 120.

Continuing further, the packaging structure 120 is adapted to be moved along its longitudinal or axial direction and in the aforenoted translational mode by means of a suitable conveyor mechanism 122, and accordingly, the packaging structure 120 is adapted to be moved along a rail member 124 which effectively serves to support the packaging structure 120 in the manner of a suitable anvil or support block such that the upper or top wall member 126 of the packaging structure 120 is disposed atop, and rides upon, an upper wall member 128 of the anvil or support block type rail member 124, while the oppositely disposed, dependent side wall members 118,119 of the packaging structure 120 are disposed adjacent to vertically oriented side wall members 130,130 of the anvil or support block type rail member 124. It is to be appreciated that a predetermined space S is defined between each side wall member 118,119 of the packaging structure 120 and a respective one of the side wall members 130,130 of the anvil or support block type rail member 124, and in this manner, the free or unimpeded conveyed movement of the packaging structure 120 along the anvil or support block type rail member 124 is effectively ensured.

These spaces S, defined between each one of the side wall member 118,119 of the packaging structure 120 and a respective one of the side wall members 130,130 of the anvil or support block type rail member 124, present an operative problem, however, when the circular saw blade 112 is moved into contact with a respective one of the side wall members 118,119 of the packaging structure 120. It is also to be noted at this junction that while only a single circular saw blade 112 has been illustrated for forming a slit within one of the side wall members 118,119 of the packaging structure 120, a corresponding or second circular saw blade may be provided for likewise forming a slit within the opposite one of the side wall members 118,119 of the packag-ing structure 120.

More particularly, it is to be appreciated that as the circular saw blade 112 is moved from the first elevated RETRACTED, INOPERATIVE position, as illustrated within FIG. 2, toward the second lowered EXTENDED, OPERATIVE position as illustrated within FIG. 3, the circular saw blade 112 will come into contact with, for example, the right side wall member 118 of the packaging structure 120. Accordingly, in the instance that only a single circular saw blade 112 is being used in connection with only a single one of the side wall members 118,119 of the packaging structure 120 whereby the packaging structure 120 would be free to move transversely toward the left, as viewed within FIG. 3, relative to the underlying anvil or support block type rail member 124, and furthermore, in the instance that the conveyor mechanism 122 is of such construction as to permit the packaging structure 120 to move transversely toward the left, as viewed within FIG. 3, relative to the underlying anvil or support block type rail member 124, then the circular saw blade 112 will, in effect, cause the packaging structure 120 to move transversely toward the left, as viewed within FIG. 3, relative to the underlying anvil or support block type rail member 124, until the right side wall member 118 of the packaging structure 120 is disposed in contact with the right side wall member 130 of the underlying anvil or support block type rail member 124. Accordingly, it will be further appreciated that as the circular saw blade 112 comes into contact with the right side wall member 118 of the packaging structure 120, and in view of the fact that the circular saw blade 112 is rotating at a high rate of speed, and in view of the additional fact that the packaging structure 120 is free to undergo the aforenoted relative movement with respect to the underlying anvil or support block type rail member 124, the initial contact defined between the rotating circular saw blade 112 and the right side wall member 118 of the packaging structure 120 will cause the right side wall member 118 of the packaging structure 120 to undergo or exhibit flexure, movement, and vibration in view of the additional fact that the right side wall member 118 of the packaging structure 120 is, at this point in time, effectively unsupported or not disposed in a stabilized manner as a result of being spaced from the right side wall member 130 of the underlying anvil or support block type rail member 124 through means of the aforenoted spaced distance S. Accordingly, still further, the circular saw blade 112 will cause the slit to be formed within the right side wall member 118 of the packaging structure 120 in an inaccurate manner whereby the formed slit will exhibit rough edge portions and improper alignment or orientation with respect to the longitudinal axis of the packaging structure 120.

Alternatively, in the instance that a pair of circular saw blades 112 are being used in connection with both side wall members 118,119 of the packaging structure 120 whereby the packaging structure 120 would not be free to move transversely toward the left, as viewed within FIG. 3, relative to the underlying anvil or support block type rail member 124, or in the instance that a only single circular saw blade 112 is being used in connection with the side wall member 118 but the conveyor mechanism 122 is of such construction as to not permit the packaging structure 120 to move transversely toward the left, as viewed in FIG. 3, relative to the underlying anvil or support block type rail member 124, then the single circular saw blade 112, or the pair of circular saw blades 112, will, in effect, cause the one or both side wall members 118,119 of the packaging structure 120 to be deflected inwardly toward the one or both side wall members 130,130 until the one or both side wall members 118, 119 of the packaging structure 120 is or are disposed in contact with the one or both of the side wall members 130 of the underlying anvil or support block type rail member 124. Thus, in a manner similar to that previously discussed, as the one or both circular saw blades 112 come into contact with the one or more side wall members 118,119 of the packaging structure 120, and in view of the fact that the one or more circular saw blades 112 are rotating at a high rate of speed, and in view of the additional fact that the one or more of the side wall members 118,119 of the packaging structure 120 are free to undergo the aforenoted deflective movement with respect to the one or more side wall members 130,130 of the underlying anvil or support block type rail member 124, the initial contact defined between the one or more rotating circular saw blades 112 and the one or more of the side wall members 118,119 of the packaging structure 120 will cause the one or more of the side wall members 118,119 of the packaging structure 120 to undergo or exhibit flexure, movement, and vibration.

As was the case in connection with the previously described instance, such flexure, movement, or vibration of the one or more side wall members 118,119 occurs in view of the additional fact that the one or more side wall members 118,119 of the packaging structure 120 are, at this point in time, effectively unsupported or are not disposed in a stabilized manner as a result of being spaced from their respective side wall members 130,130 of the underlying anvil or support block type rail member 124 through means of the aforenoted spaced distances S, wherein the deflective movements of the one or more side wall members 118,119 of the packaging structure 120 are permitted or facilitated. Accordingly, still further, the circular saw blade 112 will, again, cause the slits to be formed within the one or more side wall members 118,119 of the packaging structure 120 in an inaccurate manner whereby the formed slits will exhibit rough edge portions and improper alignment or orientation with respect to the longitudinal axis of the packaging structure 120.

Continuing further then, in order to effectively overcome or eliminate the occurrence of the aforenoted undesirable flexure, movement, or vibration of, for example, the side wall member 118 of the packaging structure 120 when the circular saw blade 112 is brought into contact therewith, so as to effectively prevent the formation of a poorly configured or inaccurately positioned or oriented slit within the side wall member 118 of the packaging structure 120, a compression implement 132, constructed in accordance with the principles and teachings of the present invention, is employed. More particularly, it is seen that the compression implement 132 comprises a lever-type mechanism having a substantially L-shaped configuration and comprising an actuating arm 134, and a compression member 136 which is disposed substantially perpendicular to the actuating arm 134. The compression member 136 is split along the longitudinal extent thereof so as to actually comprise a pair of compression arms 138,138 which are therefore laterally spaced a predetermined distance D from each other and are integrally connected together by means of a cross-piece 140 as can best be seen in FIG. 4. In this manner, the compression member 136 has a configuration similar to that of a clevis member whereby, as can best be appreciated from FIGS. 2 and 3, a peripheral edge portion of the circular saw blade 112 is adapted to be disposed within the space defined between the pair of compression arms 138,138. The compression implement 132 is operatively connected to the circular saw blade 112 so as to be movable therewith within the aforenoted vertical plane along with the circular saw blade 112 by means of the actuator mechanism 117.

In addition, it is also seen that the compression implement 132 is pivotally mounted around a pivotal axis 142, and that a suitable biasing mechanism 144, such as, for example, a spring, a pneumatic cylinder, or the like, is operatively connected to the distal or free end portion of the actuating arm 134 so as to impress a biasing force F thereon which thereby tends to cause rotation of the compression implement 132 in the clockwise direction. In a similar manner, a pair of contact elements 146, only one of which is visible in FIGS. 2 and 3, are respectively mounted upon the distal or free end portions of each one of the compression arms 138, 138 so as to be disposed upon opposite sides of the circular saw blade 112. It is to be appreciated that a critically important feature characteristic of the present invention, and more particularly, characteristic of the structure comprising the compression implement 132, resides in the fact that the length dimension of each one of the compression arms 138,138 is such that the contact elements 146, respectively mounted upon the distal or free end portions of the compression arms 138,138, will be disposed ahead, beyond, or located downstream of, the arcuate cutting portion 148 of the circular saw blade 112, which is defined by means of the peripheral edge portion of the circular saw blade 112 which actually engages the side wall member 118 of the packaging structure 120 so as to form the slit therewithin, as considered in the vertically downward movement direction when the circular saw blade 112 and the compression implement 132 are moved from the first elevated RETRACTED, INOPERATIVE position, as illustrated within FIG. 2, toward the second lowered EXTENDED, OPERATIVE position as illustrated within FIG. 3.

In this manner, when the circular saw blade 112 and the compression implement 132 are moved from the first elevated RETRACTED, INOPERATIVE position, as illustrated within FIG. 2, toward the second lowered EXTENDED, OPERATIVE position as illustrated within FIG. 3, the contact elements 146 of the compression arms 138,138 will always be biased into contact with and engage those portions of the side wall member 118 of the packaging structure 120 which are effectively disposed upon opposite sides of the location at which the slit is to be formed by means of the circular saw blade 112 prior to any contact, engagement, or cutting of such portion of the side wall member 118 of the packaging structure 120 by means of the arcuate cutting portion 148 of the circular saw blade 112. Accordingly, due to the biasing force F impressed upon the free or distal end portion of the actuating arm 134 by means of the biasing mechanism 144, the contact elements 146 of the compression arms 138,138 will either cause the packaging structure 120 to be moved transversely from right to left as viewed in FIGS. 2 and 3 whereby the right side wall member 118 of the packaging structure 120 will be disposed in contact with the right side wall member 130 of the underlying anvil or support block type rail member 124, or alternatively, the contact elements 146 of the compression arms 138,138 will cause the right side wall member 118 of the packaging structure 120 to deflect inwardly toward the right side wall member 130 of the underlying anvil or support block type rail member 124.

In either case, it will be appreciated that those portions of the right side wall member 118 of the packaging structure 120, which will effectively be disposed upon opposite sides of the location at which the slit is to be formed by means of the circular saw blade 112, will be disposed in contact with the right side wall member 130 of the underlying anvil or support block type rail member 124 so as to effectively be supported thereon in a stabilized manner prior to any contact, engagement, or cutting of the side wall member 118 of the packaging structure 120 by means of the arcuate cutting portion 148 of the circular saw blade 112. Accordingly, when the arcuate cutting portion 148 of the circular saw blade 112 does in fact contact the right side wall member 118 of the packaging structure 120 so as to form the desired slit therein, those portions of the right side wall member 118 of the packaging structure 120, which are now supported upon the right side wall member 130 of the underlying anvil or support block type rail member 124 in a stable manner, will not undergo any flexure, movement, deflection, or vibration, whereby a desirably clean, smooth, and properly oriented slit can in fact be formed within the right side wall member 118 of the packaging structure 120. It is lastly noted that, in order to be able to achieve the formation of the slit within the right side wall member 118 of the packaging structure 120 while the right side wall member 118 of the packaging structure 120 is disposed in contact with the right side wall member 130 of the underlying anvil or support block type rail member 124, the right side wall member 130 of the underlying anvil or support block type rail member 124 is provided with a vertically oriented slot 150 within which the arcuate cutting portion 148 of the circular saw blade 112 can effectively be accommodated as can best be appreciated from FIG. 3. In view of the fact that the underlying anvil or support block type rail member 124 comprises a fixed member, the slot 150 formed within the right side wall member 130 of the underlying anvil or support block type rail member 124 will always be disposed in a coplanar manner with respect to the circular saw blade 112 and the cutting station defined thereby.

Thus, it may be seen that in accordance with the principles and teachings of the present invention, there has been provided a new and improved tool system which comprises a circular saw blade which is adapted to be moved in a reciprocating manner between an elevated, RETRACTED, INOPERATIVE position and a lowered, EXTENDED, OPERATIVE position so as to repeatedly form slits within side wall members of a packaging structure at a plurality of positions which are located at predeterminedly defined locations spaced along and throughout the longitudinal or axial extent of the packaging structure. A compression implement is movable along with the circular saw blade and has a split, U-shaped or clevis-type configuration so as to define a pair of compression arms or legs. The pair of arms or legs of the compression implement are respectively disposed immediately adjacent to the opposite sides of the circular saw blade whereby, as the circular saw blade and the compression implement are moved from the elevated, RETRACTED, INOPERATIVE position toward the lowered, EXTENDED, OPERATIVE position, the pair of arms or legs of the compression implement will engage those portions of the side wall member of the packaging structure which are disposed immediately adjacent to the location within which the particular slit is to be formed by the circular saw blade so as to effectively compress or deflect such portions of the side wall member of the packaging structure against a fixed, underlying elongated anvil or support block. In this manner, the tendency of those portions of the side wall member of the packaging structure to flex and vibrate are effectively eliminated so as to facilitate the proper, accurate, clean, and smooth formation of the particular slit within the side wall member of the packaging structure.

Obviously, many variations and modifications of the present invention are possible in light of the above teachings. It is therefore to be understood that within the scope of the appended claims, the present invention may be practiced otherwise than as specifically described herein.

What is claimed as new and desired to be protected by Letters Patent of the United States of America, is:

1. A tool system for forming slits within an article, comprising:
a cutting mechanism for forming a slit within an article as said cutting mechanism moves through a stroke extending from a first position, through the article, and to a second position;
means for moving said cutting mechanism from said first position, through the article, and to said second position;
support means for supporting the article in a stabilized manner while the slit is being formed within the article by said cutting mechanism; and
a compression implement operatively associated with said cutting mechanism for pressing a portion of the article against said support means such that the article is supported upon said support means in said stabilized manner so as to ensure the proper formation of the slit within the article by said cutting mechanism.

2. The tool system as set forth in claim 1, wherein:
said cutting mechanism is mounted for reciprocal movement between said first position, at which said cutting mechanism will be disposed upon a first side of the article, and a second position, at which said cutting mechanism will be disposed upon a second side of the article, such that said cutting mechanism can form the slit within the article as the cutting mechanism moves from said first position, through the article, and reaches said second position.

3. The tool system as set forth in claim 1, wherein:
said cutting mechanism and said compression implement, movable with said cutting mechanism, are reciprocally movable in vertically oriented directions between said first and second positions.

4. The tool system as set forth in claim 1, wherein:
said cutting mechanism comprises a circular saw blade rotatable about an axis and having an outer peripheral edge portion upon which a plurality of cutting teeth are located; and
said compression implement comprises a pair of compression arms disposed immediately adjacent to opposite side surfaces of said circular saw blade so as to contact portions of the article which are effectively disposed upon opposite sides of the location at which the slit is to be formed within the article by said circular saw blade and bias those portions of the article into contact with said support means prior to any cutting of the article at the location at which the slit is to be formed by said outer peripheral edge portion of said circular saw blade.

5. The tool system as set forth in claim 4, wherein said compression implement further comprises:
a pair of contact elements mounted upon said pair of compression arms and disposed downstream of said cutting mechanism, as considered in the direction of movement of said cutting mechanism from said first position to said second position, so as to engage the article prior to the engagement of the article by said outer peripheral edge portion of said circular saw blade and thereby stabilize the article during the slit forming operation.

6. The tool system as set forth in claim 4, wherein:
said pair of arms of said compression implement are integrally connected together by means of a cross-piece such that said compression implement has a clevis-type configuration with said circular saw blade interposed between said pair of arms.

7. The tool system as set forth in claim 6, further comprising:
an actuating arm integrally connected to said cross-piece such that said actuating arm, together with said pair of arms, provide said compression implement with a substantially L-shaped configuration.

8. The tool system as set forth in claim 7, further comprising:
biasing means operatively connected to said actuating arm so as to bias said pair of compression arms toward said support means and thereby bias those portions of the article into contact with said support means.

9. The tool system as set forth in claim 8, further comprising:
means for pivotally mounting said compression element.

10. The tool system as set forth in claim 4, wherein:
slot means are defined within said support means for accommodating said outer peripheral edge portion of said circular saw blade upon which said plurality of cutting teeth are located so as to facilitate said slitting of the article.

11. A tool system for forming slits within a side wall member of a packaging structure, comprising:
a framework;
a cutting mechanism for forming a slit within a side wall member of a packaging structure as said cutting mechanism moves through a stroke extending from a first position, through the side wall member of the packaging structure, and to a second position;
means mounted upon said framework for moving said cutting mechanism from said first position, through the side wall member of the packaging structure, and to said second position;
support means for supporting the packaging structure in a stabilized manner while the slit is being formed within the side wall member of the packaging structure by said cutting mechanism; and
a compression implement operatively associated with said cutting mechanism for pressing the side wall member of the packaging structure against said support means such that the side wall member of the packaging structure is supported upon said support means in said stabilized manner so as to ensure the proper formation of the slit within the side wall member of the packaging structure by said cutting mechanism.

12. The tool system as set forth in claim 11, wherein:
said cutting mechanism is mounted for reciprocal movement between said first position, at which said cutting mechanism will be disposed upon a first side of the packaging structure, and a second position, at which said cutting mechanism will be disposed upon a second side of the packaging structure, such that said cutting mechanism can form the slit within the side wall member of the packaging structure as the cutting mechanism moves from said first position, through the side wall member of the packaging structure, and reaches said second position.

13. The tool system as set forth in claim 11, wherein:
said cutting mechanism and said compression implement, movable with said cutting mechanism, are reciprocally movable in vertically oriented directions between said first and second positions.

14. The tool system as set forth in claim 11, wherein:
said cutting mechanism comprises a circular saw blade rotatable about an axis and having an outer peripheral edge portion upon which a plurality of cutting teeth are located; and
said compression implement comprises a pair of compression arms disposed immediately adjacent to opposite side surfaces of said circular saw blade so as to contact portions of the side wall member of the packaging structure which are effectively disposed upon opposite sides of the location at which the slit is to be formed within the side wall member of the packaging structure by said circular saw blade and bias those portions of the side wall member of the packaging structure into contact with said support means prior to any cutting of the side wall member of the packaging structure at the location at which the slit is to be formed by said outer peripheral edge portion of said circular saw blade.

15. The tool system as set forth in claim 14, wherein said compression implement further comprises:
a pair of contact elements mounted upon said pair of compression arms and disposed downstream of said cutting mechanism, as considered in the direction of movement of said cutting mechanism from said first position to said second position, so as to engage the side wall member of the packaging structure prior to the engagement of the side wall member of the packaging structure by said outer peripheral edge portion of said circular saw blade and thereby stabilize the side wall member of the packaging structure during the slit forming operation.

16. The tool system as set forth in claim 14, wherein:
said pair of arms of said compression implement are integrally connected together by means of a cross-piece such that said compression implement has a clevis-type configuration with said circular saw blade interposed between said pair of arms.

17. The tool system as set forth in claim 16, further comprising:
an actuating arm integrally connected to said cross-piece such that said actuating arm, together with said pair of arms, provide said compression implement with a substantially L-shaped configuration.

18. The tool system as set forth in claim 17, further comprising:
biasing means operatively connected to said actuating arm so as to bias said pair of compression arms toward said support means and thereby bias those portions of the side wall member of the packaging structure into contact with said support means.

19. The tool system as set forth in claim 18, further comprising:
means for pivotally mounting said compression element.

20. The tool system as set forth in claim 14, wherein:
slot means are defined within said support means for accommodating said outer peripheral edge portion of said circular saw blade upon which said plurality of cutting teeth are located so as to facilitate said slitting of the side wall member of the packaging structure.
